(19) United States
(12) Patent Application Publication
(10) Pub. No.: US 2018/0007466 A1
(43) Pub. Date: Jan. 4, 2018

(54) LOUDSPEAKER ARRANGEMENT FOR THREE-DIMENSIONAL SOUND REPRODUCTION IN CARS

(71) Applicant: Fraunhofer-Gesellschaft zur Foerderung der angewandten Forschung e.V., Muenchen (DE)

(72) Inventors: Wolfgang Hess, Karlsbad (DE); Oliver Hellmuth, Budenhof (DE); Stefan Varga, Koeln (DE); Ulrik Heise, Wien (AT)

(73) Assignee: Fraunhofer-Gesellschaft zur Foerderung der angewandten Forschung e.V., Muenchen (DE)

(21) Appl. No.: 15/648,515

(22) Filed: Jul. 13, 2017

Related U.S. Application Data
(63) Continuation of application No. PCT/EP2016/051001, filed on Jan. 19, 2016.

(30) Foreign Application Priority Data
Jan. 20, 2015 (EP) 15151852.9

(51) Int. Cl. H04R 1/34; H04R 1/26; H04R 5/02

(52) U.S. Cl. CPC H04R 1/345; H04R 5/02; H04R 1/26; H04R 2499/13

(57) ABSTRACT

What is disclosed is a loudspeaker reproduction system for a vehicle having a first loudspeaker array and a second loudspeaker array. The first loudspeaker array is configured to generate a first stereo or virtual multi-channel sound field, wherein the first loudspeaker array is aligned towards a driver position of the vehicle. The second loudspeaker array is configured to generate a second stereo or virtual multi-channel sound field, wherein the second loudspeaker array is aligned towards a front passenger position of the vehicle.

### CROSS-REFERENCE TO RELATED APPLICATIONS

This application is a continuation of copending International Application No. PCT/EP2016/051001, filed Jan. 19, 2016, which is incorporated herein by reference in its entirety, and additionally claims priority from European Application No. 15151852.9, filed Jan. 20, 2015, which is also incorporated herein by reference in its entirety.

### BACKGROUND OF THE INVENTION

Embodiments relate to a loudspeaker reproduction system for a vehicle. Further embodiments relate to a method for reproducing a stereo signal in a vehicle. Some embodiments relate to a loudspeaker arrangement for three-dimensional sound reproduction in cars.

Conventionally, a multi-loudspeaker multichannel sound system is used for three-dimensional sound reproduction in vehicles. Such a multi-loudspeaker multichannel sound system comprises in a front area of the vehicle a center channel loudspeaker, a front right channel loudspeaker and a front left channel loudspeaker. The center channel loudspeaker can be arranged in a center of the dashboard, wherein the front right channel and front left channel loudspeakers can be arranged in the front doors of the vehicle or at outer right and left positions in the dashboard. Further, the multi-loudspeaker multichannel sound system comprises in a rear area of the vehicle a rear right (or surround right) channel loudspeaker and a rear left (or surround left) channel loudspeaker. The rear right and rear left channel loudspeakers can be arranged in the rear doors of the vehicle or at outer right and left positions in a rear shelf of the vehicle. Optionally, the multi-loudspeaker multichannel system can comprise at least one subwoofer.

However, a conventional multi-loudspeaker multichannel sound system entails a high cabling effort and a high number of power amplifiers. Further, a complex audio processing is involved in order to obtain the signals for the different channels of the multi-loudspeaker multichannel sound system based on a stereo signal.

Therefore, it is the object of the present invention to provide a concept for reproducing (i) a stereo or (ii) a virtual multichannel (potentially 3D) signal in a vehicle that entails less integration complexity and that has reduced audio processing demands.

### SUMMARY

According to an embodiment, a loudspeaker reproduction system for a vehicle may have: a first loudspeaker array configured to generate a first stereo or virtual multi-channel sound field, wherein the first loudspeaker array is aligned towards a driver position of the vehicle; and a second loudspeaker array configured to generate a second stereo or virtual multi-channel sound field, wherein the second loudspeaker array is aligned towards a front passenger position of the vehicle wherein the first loudspeaker array and the second loudspeaker array each have exactly two loudspeakers; and wherein the loudspeaker reproduction system is configured to reproduce one stereo signal using the first loudspeaker array and the second loudspeaker array, wherein the two loudspeakers of the first loudspeaker array are used to reproduce right and left channels of the stereo signal, respectively, wherein the two loudspeakers of the second loudspeaker array are used to reproduce right and left channels of the same stereo signal, respectively; or to reproduce one virtual multi-channel signal using the first loudspeaker array and the second loudspeaker array, wherein the loudspeaker reproduction system is configured to convert the virtual multi-channel signal in a two channel signal and to reproduce the two channel signal using the first loudspeaker array and the second loudspeaker array, wherein the two loudspeakers of the first loudspeaker array are used to reproduce right and left channels of the two channel signal, respectively, wherein the two loudspeakers of the second loudspeaker array are used to reproduce right and left channels of the same two channel signal, respectively.

According to another embodiment, a method may have the steps of: generating a first stereo or virtual multi-channel sound field with a first loudspeaker array aligned towards a driver position of a vehicle; and generating a second stereo or virtual multi-channel sound field with a second loudspeaker array aligned towards a front passenger position of the vehicle; wherein the first loudspeaker array and the second loudspeaker array each have exactly two loudspeakers; and wherein generating the first stereo or virtual multi-channel sound field and generating the second stereo or virtual multi-channel sound field has reproducing one stereo signal using the first loudspeaker array and the second loudspeaker array, wherein the two loudspeakers of the first loudspeaker array are used to reproduce right and left channels of the stereo signal, respectively, wherein the two loudspeakers of the second loudspeaker array are used to reproduce right and left channels of the same stereo, respectively; or reproducing one virtual multi-channel signal using the first loudspeaker array and the second loudspeaker array and converting the virtual multi-channel signal in a two channel signal and reproducing the two channel signal using the first loudspeaker array and the second loudspeaker array, wherein the two loudspeakers of the first loudspeaker array are used to reproduce right and left channels of the two channel signal, respectively, wherein the two loudspeakers of the second loudspeaker array are used to reproduce right and left channels of the same two channel signal, respectively.

Another embodiment may have a non-transitory digital storage medium having stored thereon a computer program for performing a method having the steps of: generating a first stereo or virtual multi-channel sound field with a first loudspeaker array aligned towards a driver position of a vehicle; and generating a second stereo or virtual multi-channel sound field with a second loudspeaker array aligned towards a front passenger position of the vehicle; wherein the first loudspeaker array and the second loudspeaker array each have exactly two loudspeakers; and wherein generating the first stereo or virtual multi-channel sound field and generating the second stereo or virtual multi-channel sound field has reproducing one stereo signal using the first loudspeaker array and the second loudspeaker array, wherein the two loudspeakers of the first loudspeaker array are used to reproduce right and left channels of the stereo signal, respectively, wherein the two loudspeakers of the second loudspeaker array are used to reproduce right and left channels of the same stereo, respectively; or reproducing one virtual multi-channel signal using the first loudspeaker array and the second loudspeaker array and converting the virtual multi-channel signal in a two channel signal and reproducing the two channel signal using the first loudspeaker array and the second loudspeaker array, wherein the two loudspeakers of the first loudspeaker array are used to reproduce right and left channels of the two channel signal, respectively, wherein the two loudspeakers of the second loudspeaker array are used to reproduce right and left channels of the same two channel signal, respectively, when said computer program is run by a computer.

Embodiments provide a loudspeaker reproduction system for a vehicle. The loudspeaker reproduction system comprises a first loudspeaker array and a second loudspeaker array. The first loudspeaker array is configured to generate a first stereo or virtual multi-channel sound field, wherein the first loudspeaker array is aligned towards a driver position of the vehicle. The second loudspeaker array is configured to generate a second stereo or virtual multi-channel sound field, wherein the second loudspeaker array is aligned towards a front passenger position of the vehicle.

According to the concept of the present invention, a conventional multi-loudspeaker multichannel sound system is replaced by two loudspeaker arrays, wherein the two loudspeaker arrays are arranged such that one of the loudspeaker arrays is aligned or directed towards a position of a driver in the vehicle for generating a stereo or virtual multi-channel sound field for the driver of the vehicle and the other of the two loudspeaker arrays is aligned or directed towards a position of a front passenger of the vehicle for generating a stereo or virtual multi-channel sound field for the front passenger of the vehicle.

Further embodiments provide a method for reproducing a stereo signal in a vehicle. The method comprises:
generating a first stereo or virtual multi-channel sound field with a first loudspeaker array aligned towards a driver position of a vehicle; and
generating a second stereo or virtual multi-channel sound field with a second loudspeaker array aligned towards a front passenger position of the vehicle.

### BRIEF DESCRIPTION OF THE DRAWINGS

Embodiments of the present invention are described herein making reference to the appended figures, in which:

FIG. 1 shows a schematic top-view of a vehicle with a loudspeaker reproduction system according to an embodiment;

FIG. 2 shows a schematic top-view of the vehicle and the loudspeaker reproduction system according to a further embodiment;

FIG. 3a shows a schematic top-view of the vehicle with the loudspeaker reproduction system and a driver and front passenger, according to a further embodiment;

FIG. 3b shows a schematic top view of the loudspeaker reproduction system, the driver and the front passenger shown in FIG. 3a and sound paths between loudspeakers of the loudspeaker reproduction system and the driver and front passenger of the vehicle, according to an embodiment;

FIG. 4 shows a schematic top-view of the vehicle with the loudspeaker reproduction system according to an embodiment;

FIG. 5 shows a cross-sectional side-view of the vehicle and the loudspeaker reproduction system according to an embodiment; and

FIG. 6 shows a flowchart of a method for reproducing a stereo signal, according to an embodiment.

### DETAILED DESCRIPTION OF THE INVENTION

Equal or equivalent elements or elements with equal or equivalent functionality are denoted in the following description by equal or equivalent reference numerals.

In the following description, a plurality of details are set forth to provide a more thorough explanation of embodiments of the present invention. However, it will be apparent to one skilled in the art that embodiments of the present invention may be practiced without these specific details. In other instances, well-known structures and devices are shown in block diagram form rather than in detail in order to avoid obscuring embodiments of the present invention. In addition, features of the different embodiments described hereinafter may be combined with each other, unless specifically noted otherwise.

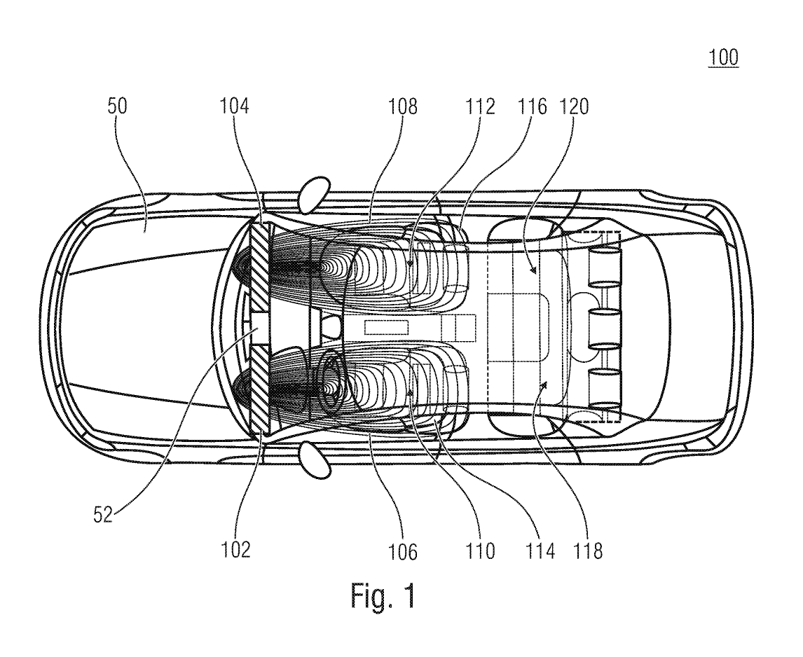

FIG. 1 shows a schematic top-view of a vehicle 50 with a loudspeaker reproduction system 100 according to an embodiment. The loudspeaker reproduction system 100 comprises a first loudspeaker array 102 and a second loudspeaker array 104. The first loudspeaker array 102 is configured to generate a first stereo or virtual multi-channel (e.g., three-dimensional) sound field 106, wherein the first loudspeaker array 102 is aligned towards a driver position 110 of the vehicle 50, such that the first stereo or virtual multi-channel (e.g., three dimensional) sound field 106 is directed towards the driver position 110. The second loudspeaker array 104 is configured to generate a second stereo or virtual multi-channel sound field 108, wherein the second loudspeaker array 104 is aligned towards a front passenger position 112 of the vehicle, such that the second stereo or virtual multi-channel sound field 108 is directed towards the front passenger position 112.

The first loudspeaker array 102 and the second loudspeaker array 104 can be arranged, for example, in a dashboard 52 of the vehicle 50. Thereby, the first loudspeaker array 102 can be arranged in the dashboard such that the first stereo or virtual multi-channel sound field 106 is directed towards the driver position 110, wherein the second loudspeaker array 104 can be arranged in the dashboard such that the second stereo or virtual multi-channel sound field 108 is directed towards the front passenger position 112.

As exemplarily shown in FIG. 1, the vehicle 50 can be a car. The car may at least comprise a driver seat 114 and a front passenger seat 116. Thereby, the driver position 110 may be defined by a position of the driver seat 114, wherein the front passenger position 112 may be defined by a position of the front passenger seat 116. For example, the driver position 110 may correspond to (or be) a position in which a head of a driver that is sitting on the driver seat 114 would be arranged. Similarly, the front passenger position 112 may correspond to (or be) a position in which a head of a front passenger that is sitting on the front passenger seat 116 would be arranged.

Naturally, the car may further comprise at least two rear seats or at least one rear bench seat for at least two more passengers. As becomes obvious from FIG. 1, in that case, first and second stereo or virtual multi-channel sound fields 106 and 108 are also directed towards rear passenger positions 118 and 120 arranged behind the driver and front passenger positions 110 and 112, e.g. towards rear passengers who are sitting behind the driver (seat) and front passenger (seat), respectively.

In order to generate the first stereo or virtual multi-channel sound field 106 such that same is directed towards the driver position 110 (and optionally towards a rear passenger position 118 behind the driver position 110), the first loudspeaker array can be arranged symmetrically with respect to the driver position 110. In the same way, the second loudspeaker array 104 can be arranged symmetrically with respect to the front passenger position 110, such that the second stereo or virtual multi-channel sound field 108 is directed towards the front passenger position 112 (and optionally towards a rear passenger position 120 behind the front passenger position 112).

The first loudspeaker array 102 can be arranged such that a distance between the first loudspeaker array 102 and the driver position 110 is smaller than a distance between the second loudspeaker array 104 and the driver position 110. Similarly, the second loudspeaker array 102 can be arranged such that a distance between the second loudspeaker array 104 and the front passenger position 112 is smaller than a distance between the first loudspeaker array 102 and the front passenger position 112.

By arranging the first loudspeaker array 102 and the second loudspeaker array 104 in such a manner, the first stereo or virtual multi-channel sound field 106 and the second stereo or virtual multi-channel sound field 108 are subject to the precedence effect at the driver position 110 and the front passenger position 112, respectively.

According to the precedence effect (or law of the first wave front), when a sound is followed by another sound separated by a sufficiently short time delay (below the listener's echo threshold), listeners perceive a single fused auditory image and its perceived spatial location is dominated by the location of the first-arriving sound (the first wave front).

Thus, due to the precedence effect, the auditory image perceived at the drivers position 110 is dominated by the sound (or wave front) generated by first loudspeaker array 102, wherein the auditory image perceived at the front passenger position 112 is dominated by the sound (or wave front) generated by the second loudspeaker array 104. In other words, due to the precedence effect, a driver of the vehicle 50 will hear the first stereo or virtual multi-channel sound field 106 generated by the first loudspeaker array 102, wherein a front passenger will hear the second stereo or virtual multi-channel sound field 108 generated by the second loudspeaker array 104.

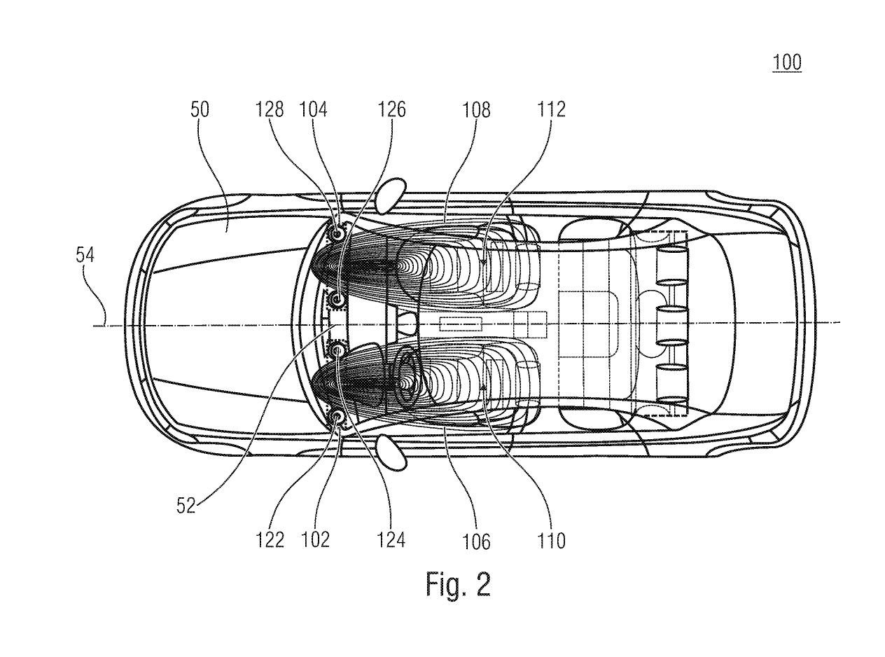

FIG. 2 shows a schematic top-view of the vehicle 50 with the loudspeaker reproduction system 100 according to a further embodiment. In contrast to FIG. 1, in FIG. 2 loudspeakers of the first and second loudspeaker arrays 102 and 104 are shown.

The first loudspeaker array 102 and the second loudspeaker array 104 can each comprise exactly two loudspeakers 122, 124, 126 and 128, i.e. the first loudspeaker array 102 can comprise a first loudspeaker 122 and a second loudspeaker 124, and the second loudspeaker array 104 can comprise a third loudspeaker 126 and a fourth loudspeaker 128.

Each of the loudspeakers 122, 124, 126 and 128 can comprise one loudspeaker driver (e.g., a full-range driver or wide-range driver) or a plurality of loudspeaker drivers for different frequency bands (e.g., a high-frequency driver (tweeter) and mid-frequency driver; a high-frequency driver (tweeter) and a woofer; or a high-frequency driver (tweeter), a mid-frequency driver and a woofer).

The loudspeaker reproduction system 100 can be configured to reproduce one stereo or virtual multi-channel signal (or the same stereo or virtual multi-channel signal) using the first loudspeaker array 102 and the second loudspeaker array 104. Thereby, the loudspeaker reproduction system 100 may be configured to convert the virtual multi-channel signal in a two channel signal (or two loudspeaker channel signal, i.e. two loudspeaker channels) and to reproduce the two channel signal using the first loudspeaker array 102 and the second loudspeaker array 104, in order to reproduce the virtual multi-channel signal. The two loudspeakers 122 and 124 of the first loudspeaker array 102 can be used to reproduce right and left channels of the stereo signal or two channel signal, respectively, wherein the two loudspeakers 126 and 128 of the second loudspeaker array 104 can be used to reproduce right and left channels of the same stereo or two channel signal, respectively. In detail, the first loudspeaker 122 can be used to reproduce a left channel of the stereo or two channel signal, wherein the second loudspeaker 124 can be used to reproduce the right channel of the stereo or two channel signal. Further, the third loudspeaker 126 can be used to reproduce the left channel of the stereo or two channel signal, wherein the fourth loudspeaker 128 can be used to reproduce the right channel of the stereo or two channel signal. Thus, loudspeakers of the first loudspeaker array 102 and the second loudspeaker array 104 which are arranged immediately adjacent to each other (i.e., without any other loudspeaker in between) are configured to reproduce different channels of the same stereo or two channel signal.

In order to increase or boost the precedence effect, loudspeakers of the first loudspeaker array 102 and the second loudspeaker array 104 which are arranged closer to a middle of the vehicle 50 (e.g., the second loudspeaker 124 and the third loudspeaker 126) can be driven with a lower volume than loudspeakers of the first loudspeaker array 102 and the second loudspeaker array which are arranged farer away from the middle of the vehicle 50 (e.g. the first loudspeaker 122 and the fourth loudspeaker 128).

Further, loudspeakers of the first loudspeaker array 102 and the second loudspeaker array 104 which are arranged closer to a middle of the vehicle 50 (e.g. the second loudspeaker 124 and the third loudspeaker 126) can be driven delayed by 5 to 15 samples (or 7 to 13, or 8 to 12 samples, or 10 samples) compared to loudspeakers of the first loudspeaker array 102 and the second loudspeaker array 104 which are arranged farer away from the middle of the vehicle 50.

In a top view (e.g., the view used in FIGS. 1 and 2), the vehicle middle 52 can elongate symmetrically (along a symmetry line or symmetry plane) in the middle of the vehicle from a front of the vehicle to a rear of the vehicle with respect to listening positions 110 and 118 at the driver's side of the vehicle and with respect to listening positions 112 and 120 at the passenger's side of the vehicle.

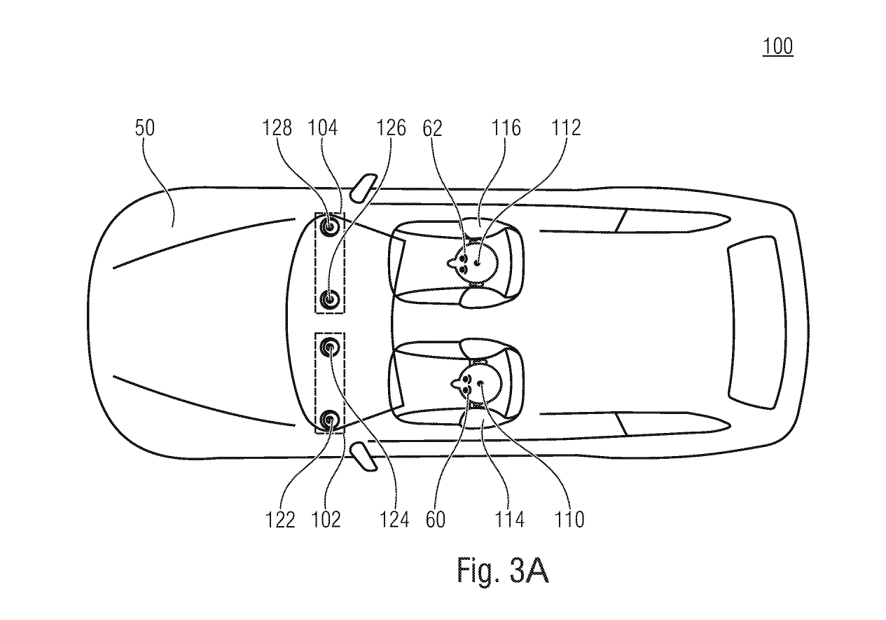

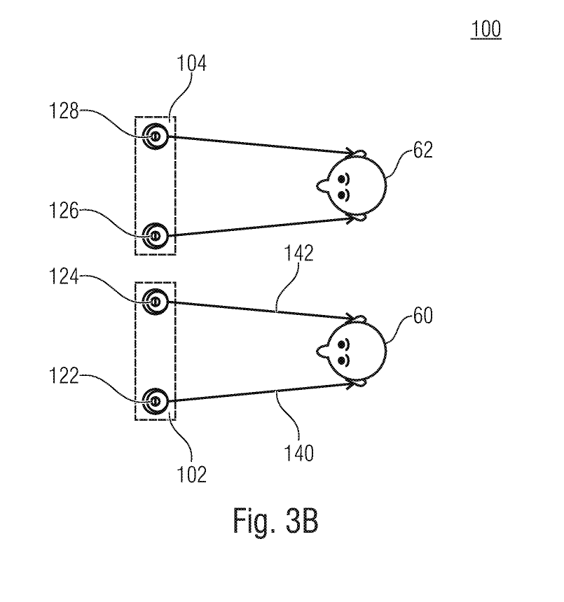

FIG. 3a shows a schematic top-view of the vehicle 50 with the loudspeaker reproduction system 100 according to a further embodiment. Further, in FIG. 3 a driver 60 and a front passenger 62 are shown. The driver 60 is sitting on the driver seat 114 such that driver 60 (or head of the driver60) is located at the driver position, wherein the front passenger 62 is sitting on the front passenger seat 116 such that the front passenger 62 (or head of the front passenger 62) is located at the front passenger position 112. More precisely, the driver (listening) position 110 can be defined as a center between ears of the driver 60, wherein the front passenger (listening) position 112 can be defined as a center between ears of the front passenger 62.

The first loudspeaker array 102, or more precisely, the two loudspeakers 122 and 124 of the first loudspeaker array 102, are arranged symmetrically with respect to the driver position 110, wherein the second loudspeaker array 104, or more precisely, the two loudspeakers 126 and 128 of the second loudspeaker array 104 are arranged symmetrically with respect to the front passenger position 112. Thus, FIG. 3 shows a symmetrical listening position.

FIG. 3b shows a schematic top view of the loudspeaker reproduction system 100, the driver 60 and the front passenger 62 shown in FIG. 3a and sound paths between loudspeakers of the loudspeaker reproduction system 100 and the driver 60 and front passenger 62 of the vehicle, according to an embodiment.

A first sound path 140 extends from the first loudspeaker 122 (left channel loudspeaker) of the first loudspeaker array 102 to a left ear of the driver 60, wherein a second sound path 142 extends from the second loudspeaker 124 (right channel loudspeaker) of the second loudspeaker array 102 to a right ear of the driver 60, wherein a third sound path 144 extends from the third loudspeaker 126 (left channel loudspeaker) of the second loudspeaker array 104 to a left ear of the front passenger 62, and wherein a fourth sound path 146 extends from the fourth loudspeaker 128 (right channel loudspeaker) of the second loudspeaker array 104 to a right ear of the front passenger 62. Thus, FIG. 3b shows sound paths of a symmetrical listening position.

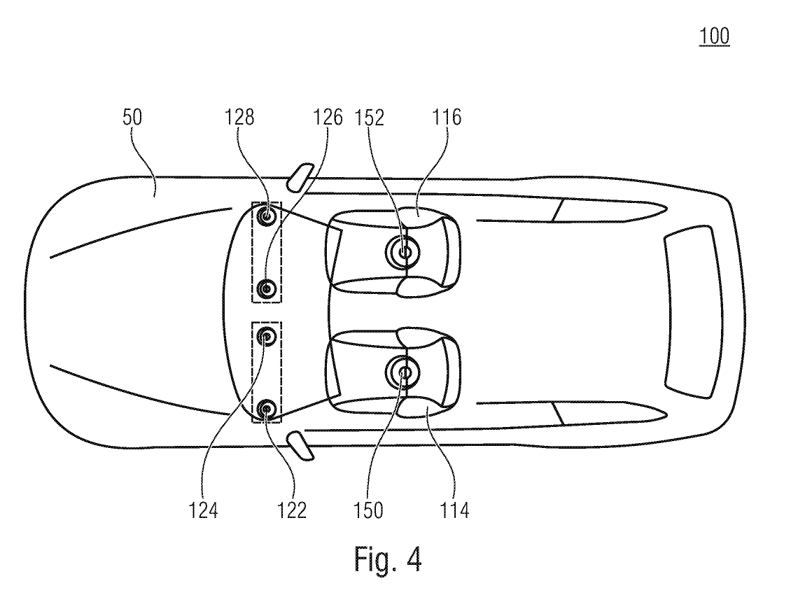

FIG. 4 shows a schematic top-view of the vehicle 50 with the loudspeaker reproduction system 100 according to an embodiment. The loudspeaker reproduction system 100 may further comprise at least one subwoofer. The at least one subwoofer can be arranged, for example, in the rear shelf of the vehicle, in the luggage compartment or underneath a seat, such as the driver seat 114, the front passenger seat 116 or the rear bench seat.

As exemplarily sown in FIG. 4, the loudspeaker reproduction system 100 can comprise two additional subwoofers 150 and 152 arranged underneath the driver seat 114 and the front passenger seat 116, respectively.

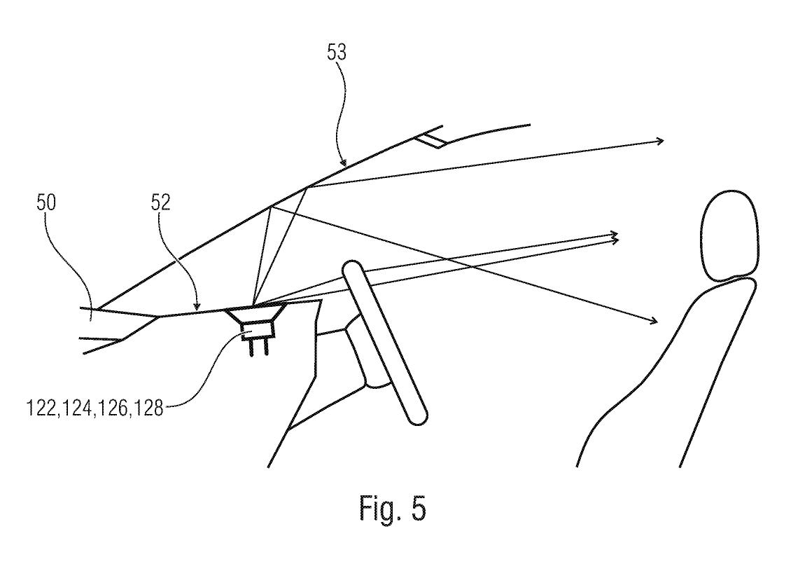

FIG. 5 shows a cross-sectional side-view of the vehicle 50 and the loudspeaker reproduction system 100 according to an embodiment. Loudspeakers 122, 124, 126 and 128 of the loudspeaker reproduction system 100 can be arranged, for example, in the dashboard 52 of the vehicle 50.

As shown in FIG. 5, the loudspeakers 122, 124, 126 and 128 can be arranged in the dashboard such that primary sound emitting directions of the loudspeakers 122, 124, 126 and 128 are directed against a windshield 53 of the vehicle 50. In FIG. 5, sound paths between the loudspeakers 122, 124, 126 and 128 and the respective listening positions caused due to reflections at the windshield 53 are indicated by arrows. As can be gathered from FIG. 5, a height of a sound stage can be increased due to the reflections at the windshield 53.

In embodiments, four loudspeakers 122, 124, 126 and 128 can be mounted in the dashboard of a car and replace a vehicle multi-loudspeaker multichannel sound system for 3-D (three-dimensional) sound reproduction. These loudspeakers 122, 124, 126 and 128 can be placed mostly in a row, symmetrically positioned to the listener, in the top of the dashboard 52 radiating sound against the windshield 53 of the car 50. No direct sound path connection to the ears is involved. One loudspeaker pair 122 and 124, and 126 and 128 is needed for two listeners sitting one after another (front seat and back seat).

In embodiments, a frontal sound stage is provided. A stable individual sound stage in front of each listener can be reached by some samples delay and few dB gain adjustment of the mid loudspeakers 124 and 126. Spatial sound is non-individual. As an amendment or to support very small loudspeakers in the dashboard 52, two subwoofers 150 and 152 can be placed below the front seats 114 and 116 or elsewhere in the car 50. Also on the rear seats a stable individual frontal sound stage and a stable acoustical room perception can be reached due to the symmetrical seating position (front/rear) in the car 50. For an eased sound system tuning process, symmetrical or near symmetrical positioning of the loudspeakers may be used.

In embodiments, a non-individual auditory spatial perception is provided. A broadening of the height of the sound image can be reached by reflections against the windshield 53. When spatial information is added to the standard stereo-mix, the sound stage remains stable in height due to direct radiation of sound against the windshield. The spatial perception is not limited to one seat, but a common feature of 3-D reproduction in the whole vehicle.

Embodiments provide the following advantages:
Cheap sound system through easy integration of the whole sound reproducing hardware (loudspeakers) in the dashboard of the car.
Cheap, short and easy cabling—only from the head unit to the loudspeakers
No cabling to the rear-part of the car and cabling into car doors involved.
Limited number of loudspeakers (4 or 4+2 Subwoofers) and limited number of power amplifier channels.
Limited number of audio signal processing stages (equalizer, cross-over, delay, etc.) and needed processing power.
Saving of room in the car, weight of the car and electrical power consumption, i.e. it is fuel saving.
Eased audio signal processing architecture.
Eased and faster sound system tuning process (only 4 channels, symmetry can be used, no different sound tuning for front seats and rear seats of the car).
Easy prove of architecture by sight.

Further, it is not necessary to use a camera for correcting the generated sound field when a driver or passenger of the vehicle changes moves or rotates the head. Additionally, it is possible to use standard loudspeakers, instead of large planar loudspeakers or electrostats employing special amplifiers. It is also possible to supply pairs of seats (driver's seat and back seat behind it) (front passenger seat and back seat behind it) completely via the front loudspeakers so that installing loudspeakers into the rear shelf, for example, is not necessary. This entails uniform sound tuning (no different sound tuning required for front/back or left/right). Tuning may also be done only for one pair of loudspeakers, which may then be mirrored and copied.

That means that embodiments may one or more of:
replace a complete multichannel multi-loudspeaker 3-D vehicle sound system
add height information to standard stereo setup by reflections
use loudspeakers off-the-shelf (standard types) mounted in the dashboard without heightening of construction or something else. Loudspeakers are inserted into the dashboard for an unbroken surface.
use small loudspeakers in the dashboard supported by subwoofers (or woofers) mounted under the front seats.
use a symmetrical arrangement of those loudspeakers wherein tuning can be done symmetrically.
use front loudspeakers to supply front and rear seats with 3-D sound.
generate no individual, but a common 3-D soundfield, independent of listening position.
achieve stable sound-stage height when mono/stereo input signals are presented in 3-D sound.

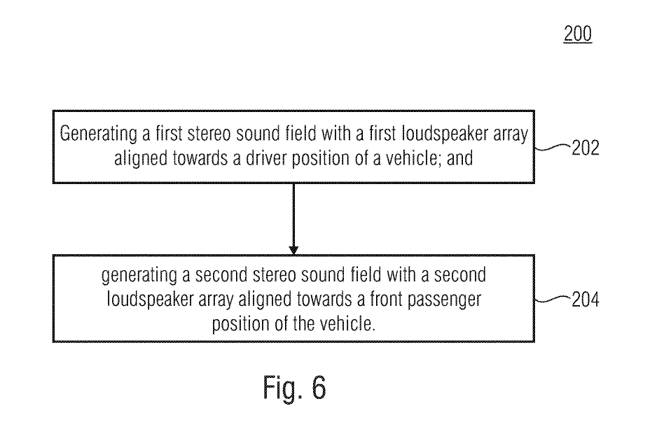

FIG. 6 shows a flowchart of a method for reproducing a stereo signal, according to an embodiment. The method 200 comprises a step 202 of generating a first stereo or virtual multi-channel signal sound field with a first loudspeaker array aligned towards a driver position of a vehicle; and a step 204 of generating a second stereo or virtual multi-channel signal sound field with a second loudspeaker array aligned towards a front passenger position of the vehicle.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, one or more of the most important method steps may be executed by such an apparatus.

Depending on certain implementation requirements, embodiments of the invention can be implemented in hardware or in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitionary.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods may be performed by any hardware apparatus.

The apparatus described herein may be implemented using a hardware apparatus, or using a computer, or using a combination of a hardware apparatus and a computer.

The apparatus described herein, or any components of the apparatus described herein, may be implemented at least partially in hardware and/or in software.

The methods described herein may be performed using a hardware apparatus, or using a computer, or using a combination of a hardware apparatus and a computer.

The methods described herein, or any components of the apparatus described herein, may be performed at least partially by hardware and/or by software.

While this invention has been described in terms of several embodiments, there are alterations, permutations, and equivalents which will be apparent to others skilled in the art and which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. A loudspeaker reproduction system for a vehicle, the loudspeaker reproduction system comprising:
a first loudspeaker array configured to generate a first stereo or virtual multi-channel sound field, wherein the first loudspeaker array is aligned towards a driver position of the vehicle; and
a second loudspeaker array configured to generate a second stereo or virtual multi-channel sound field, wherein the second loudspeaker array is aligned towards a front passenger position of the vehicle,
wherein the first loudspeaker array and the second loudspeaker array each comprise exactly two loudspeakers; and
wherein the loudspeaker reproduction system is configured
to reproduce one stereo signal using the first loudspeaker array and the second loudspeaker array, wherein the two loudspeakers of the first loudspeaker array are used to reproduce right and left channels of the stereo signal, respectively, wherein the two loudspeakers of the second loudspeaker array are used to reproduce right and left channels of the same stereo signal, respectively;
or to reproduce one virtual multi-channel signal using the first loudspeaker array and the second loudspeaker array, wherein the loudspeaker reproduction system is configured to convert the virtual multi-channel signal in a two channel signal and to reproduce the two channel signal using the first loudspeaker array and the second loudspeaker array, wherein the two loudspeakers of the first loudspeaker array are used to reproduce right and left channels of the two channel signal, respectively, wherein the two loudspeakers of the second loudspeaker array are used to reproduce right and left channels of the same two channel signal, respectively.

2. The loudspeaker reproduction system according to claim 1, wherein the first loudspeaker array is arranged symmetrically with respect to the driver position; and
wherein the second loudspeaker array is arranged symmetrically with respect to the front passenger position.

3. The loudspeaker reproduction system according to claim 1, wherein the first loudspeaker array is arranged such that a distance between the first loudspeaker array and the driver position is smaller than a distance between the second loudspeaker array and the driver position.

4. The loudspeaker reproduction system according to claim 1, wherein each of the loudspeakers) comprises one loudspeaker driver or a plurality of loudspeaker drivers for different frequency bands.

5. The loudspeaker reproduction system according to claim 1, wherein loudspeakers of the first loudspeaker array and the second loudspeaker array which are arranged at a smaller distance to a middle of the vehicle are driven with a lower volume than loudspeakers of the first loudspeaker array and the second loudspeaker array which are arranged at a greater distance to a middle of the vehicle.

6. The loudspeaker reproduction system according to claim 1, wherein loudspeakers of the first loudspeaker array and the second loudspeaker array which are arranged at a smaller distance to a middle of the vehicle are driven delayed by 5 to 20 samples compared to loudspeakers of the first loudspeaker array and the second loudspeaker array which are arranged at a greater distance to the middle of the vehicle.

7. The loudspeaker reproduction system according to claim 4, wherein loudspeakers of the first loudspeaker array and the second loudspeaker array which are arranged immediately adjacent to each other are configured to reproduce different channels of the same stereo or virtual multi-channel signal.

8. The loudspeaker reproduction system according to claim 1, wherein loudspeakers of the first loudspeaker array and the second loudspeaker array are arranged in a dashboard of the vehicle.

9. The loudspeaker reproduction system according to claim 8, wherein the loudspeakers are arranged in the dashboard such that primary sound emitting directions of the loudspeakers are directed against a windshield of the vehicle.

10. The loudspeaker reproduction system according to claim 1, wherein loudspeakers of the first loudspeaker array and the second loudspeaker array are arranged in a dashboard and/or A-pillar of the vehicle such that primary sound emitting directions of the loudspeakers are directed towards the driver position and the front passenger position, respectively.

11. The loudspeaker reproduction system according to claim 1, wherein loudspeakers of the first loudspeaker array and the second loudspeaker array are substantially arranged in a row.

12. The loudspeaker reproduction system according to claim 1, wherein loudspeaker reproduction system is configured to reproduce the same stereo or virtual multi-channel signal with the first loudspeaker array and the second loudspeaker array.

13. The loudspeaker reproduction system according to claim 12, wherein the loudspeaker reproduction system is configured to reproduce the same stereo or virtual multi-channel signal with the first loudspeaker array and the second loudspeaker array such that immediately adjacent loudspeakers of the first loudspeaker array and the second loudspeaker array reproduce different channels of the same stereo or virtual multi-channel signal.

14. A method, comprising:
generating a first stereo or virtual multi-channel sound field with a first loudspeaker array aligned towards a driver position of a vehicle; and
generating a second stereo or virtual multi-channel sound field with a second loudspeaker array aligned towards a front passenger position of the vehicle;
wherein the first loudspeaker array and the second loudspeaker array each comprise exactly two loudspeakers; and
wherein generating the first stereo or virtual multi-channel sound field and generating the second stereo or virtual multi-channel sound field comprises
reproducing one stereo signal using the first loudspeaker array and the second loudspeaker array, wherein the two loudspeakers of the first loudspeaker array are used to reproduce right and left channels of the stereo signal, respectively, wherein the two loudspeakers of the second loudspeaker array are used to reproduce right and left channels of the same stereo, respectively;
or reproducing one virtual multi-channel signal using the first loudspeaker array and the second loudspeaker array and converting the virtual multi-channel signal in a two channel signal and reproducing the two channel signal using the first loudspeaker array and the second loudspeaker array, wherein the two loudspeakers of the first loudspeaker array are used to reproduce right and left channels of the two channel signal, respectively, wherein the two loudspeakers of the second loudspeaker array are used to reproduce right and left channels of the same two channel signal, respectively.

15. A non-transitory digital storage medium having stored thereon a computer program for performing a method, comprising:
generating a first stereo or virtual multi-channel sound field with a first loudspeaker array aligned towards a driver position of a vehicle; and
generating a second stereo or virtual multi-channel sound field with a second loudspeaker array aligned towards a front passenger position of the vehicle;
wherein the first loudspeaker array and the second loudspeaker array each comprise exactly two loudspeakers; and
wherein generating the first stereo or virtual multi-channel sound field and generating the second stereo or virtual multi-channel sound field comprises
reproducing one stereo signal using the first loudspeaker array and the second loudspeaker array, wherein the two loudspeakers of the first loudspeaker array are used to reproduce right and left channels of the stereo signal, respectively, wherein the two loudspeakers of the second loudspeaker array are used to reproduce right and left channels of the same stereo, respectively;
or reproducing one virtual multi-channel signal using the first loudspeaker array and the second loudspeaker array and converting the virtual multi-channel signal in a two channel signal and reproducing the two channel signal using the first loudspeaker array and the second loudspeaker array, wherein the two loudspeakers of the first loudspeaker array are used to reproduce right and left channels of the two channel signal, respectively, wherein the two loudspeakers of the second loudspeaker array are used to reproduce right and left channels of the same two channel signal, respectively,
when said computer program is run by a computer.
